(19) United States
(12) Patent Application Publication
(10) Pub. No.: US 2020/0401279 A1
(43) Pub. Date: Dec. 24, 2020

(54) USER INTERFACE FOR PROVIDING MACHINE-LEARNED REVIEWER RECOMMENDATIONS

(71) Applicant: Microsoft Technology Licensing, LLC, Redmond, WA (US)

(72) Inventors: Karthik Dundee Jayachandar Naidu, Mountain View, CA (US); Hong Yao, Fremont, CA (US); Jefferson Lai, San Jose, CA (US)

(21) Appl. No.: 16/447,433

(22) Filed: Jun. 20, 2019

(51) Int. Cl. G06F 3/0482; G06N 20/00; G06N 5/04

(52) U.S. Cl. CPC G06F 3/0482; G06N 5/04; G06N 20/00

(57) ABSTRACT

Techniques for providing a user interface configured to provide recommendations of content reviewers using machine learning are disclosed herein. In some embodiments, a computer system receives an indication of a first user associated with a creation of an electronic message, identifies a first set of one or more other users for the first user using a recommendation model, and causes a corresponding indication of each one of the identified first set of one or more other users to be displayed as a recommended recipient of the electronic message within a user interface of a computing device. In some example embodiments, a user selection of the corresponding indication of one of the identified first set of other users is received, and an address field of the electronic message is populated with an electronic address of the selected one of the identified first set of other users based on the user selection.

### TECHNICAL FIELD

The present application relates generally to systems and methods, and computer program products for providing a user interface configured to provide recommendations of content reviewers using machine learning.

### BACKGROUND

When a user of an online service authors an electronic message via a message creation process of the online service, in some situations, the user does not know to whom the electronic message should be addressed. For example, if the user is intending to request, via the electronic message, that another user review certain content and provide feedback, the user who is authoring the electronic message may often be unsure as to who the most relevant or appropriate person is to review the content (e.g., who can provide meaningful, relevant, and useful feedback). As a result of the user being unsure as to whom the electronic message should be addressed, and such information not being conveniently provided to the user, the user often selects another user that is not likely to provide adequate feedback. The user then repeats the process of creating another electronic message, selecting another recipient, and transmitting the newly created message to the new recipient. The repeated creation and transmission of electronic messages resulting from the ineffective addressing of the electronic messages wastes network bandwidth associated with the transmission of the ineffective electronic messages, thereby slowing down network communication, and wastes storage space associated with the storage of the ineffective electronic messages.

Additionally, as a result of the user being unsure as to whom the electronic message should be addressed and such information not being conveniently provided to the user, the user also browses the online service to find an appropriate recipient, requiring the user to navigate away from the user interface view of the electronic message being created to one or more other pages in search of the appropriate recipient, again consuming network bandwidth in this discovery process. Furthermore, in the process of searching for the appropriate recipient, the display screen of the user's computing device is consumed by the navigation process, wasting graphic user interface real estate and taking the user away from the view of the electronic message, making the message creation process inconvenient. In addition to the technical problems discussed above, other technical problems may arise as well as a result of the user being unsure as to whom the electronic message should be addressed, and such information not being conveniently provided to the user.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a recommendation system, in accordance with an example embodiment.

FIGS. 4-12 illustrate user interfaces at different stages of providing recommendations of content reviewers, in accordance with an example embodiment.

FIG. 13 is a flowchart illustrating a method of providing recommendations of content reviewers, in accordance with an example embodiment.

FIG. 14 is a block diagram illustrating a mobile device, in accordance with some example embodiments.

FIG. 15 is a block diagram of an example computer system on which methodologies described herein may be executed, in accordance with an example embodiment.

### DETAILED DESCRIPTION

### I. Overview

Example methods and systems of providing a user interface configured to provide recommendations of content reviewers using machine learning are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. In some example embodiments, a specially-configured computer system identifies, for a first user, one or more other users based on a recommendation model, and causes a corresponding indication of each one of the identified one or more other users to be displayed as a recommended recipient of an electronic message being created within a user interface of a computing device of the first user. The first user may select one of the identified other users as the recipient of the electronic message, thereby causing an address field of the electronic message to be populated with a corresponding electronic address of the selected other user. The recommendation model may be based on any of one or more factors, such as a measure of similarity between the first user and the other users (e.g., based on user profile data), a measure of interaction between the first user and the other users, and content of the electronic message being created. Behavior data indicating whether or not the first user selected the recommended recipients and behaviour data indicating whether or not the selected recommended recipients responded to the electronic message may be used as training data in a machine learning process to modify the recommendation model.

The implementation of the features disclosed herein involves a non-generic, unconventional, and non-routine operation or combination of operations. By applying one or more of the solutions disclosed herein, some technical effects of the system and method of the present disclosure are to provide relevant and appropriate recommendations of recipients for an electronic message being created, thereby reducing the consumption of electronic resources (e.g., network bandwidth, storage space, screen space) associated with a user selecting inappropriate recipients for the electronic message and a user browsing an online service in search of a recipient for the electronic message. As a result, the functioning of the computer system is improved. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

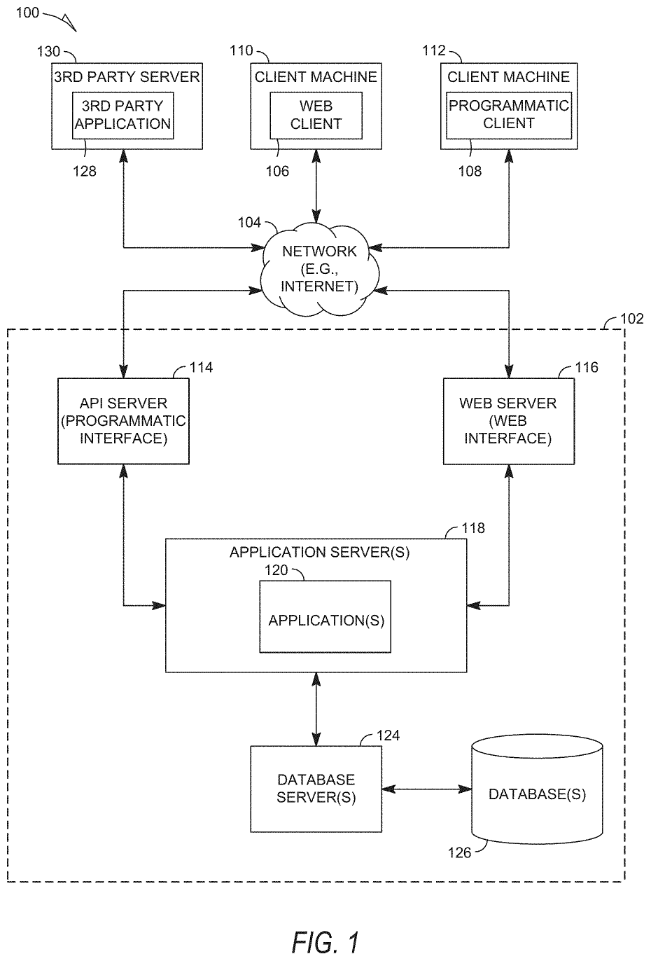

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third-party. The third-party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

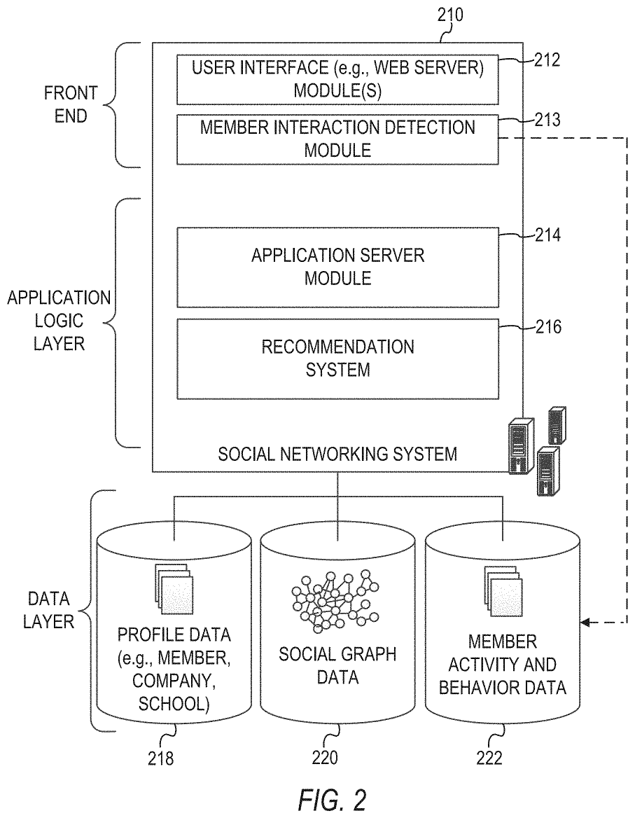

In some embodiments, the networked system 102 may comprise functional components of a social networking service. FIG. 2 is a block diagram showing the functional components of a social networking system 210, including a data processing module referred to herein as a recommendation system 216, for use in social networking system 210, consistent with some embodiments of the present disclosure. In some embodiments, the recommendation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the recommendation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the recommendation system 216. The members' interactions and behavior may also be tracked, stored, and used by the recommendation system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third-party applications and services.

Although the recommendation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

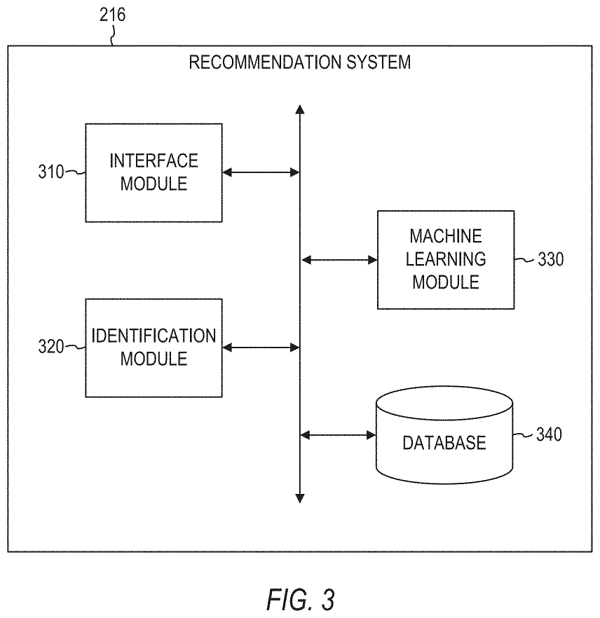

FIG. 3 is a block diagram illustrating an environment 300 in which the recommendation system 216 is implemented, in accordance with an example embodiment. In some example embodiments, the recommendation system 216 is configured to provide recommendations of content reviewers using machine-learned recommendation model. In some example embodiments, the recommendation system 216 comprises any combination of one or more of an interface module 310, an identification module 320, a machine learning module 330, and one or more database(s) 340. The modules 310, 320, and 330, and the database(s) 340 can reside on a computer system, or other machine, having a memory and at least one processor (not shown). In some embodiments, the modules 310, 320, and 330, and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, and the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third-party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 330, as well as extract attributes and/or characteristics from the profile data of member profiles. Furthermore, the one or more of the modules 310, 320, and 330 can access social graph data and member activity and behavior data from database(s) 340, as well as exchange information with third-party servers 130, client machines 110, 112, and other sources of information.

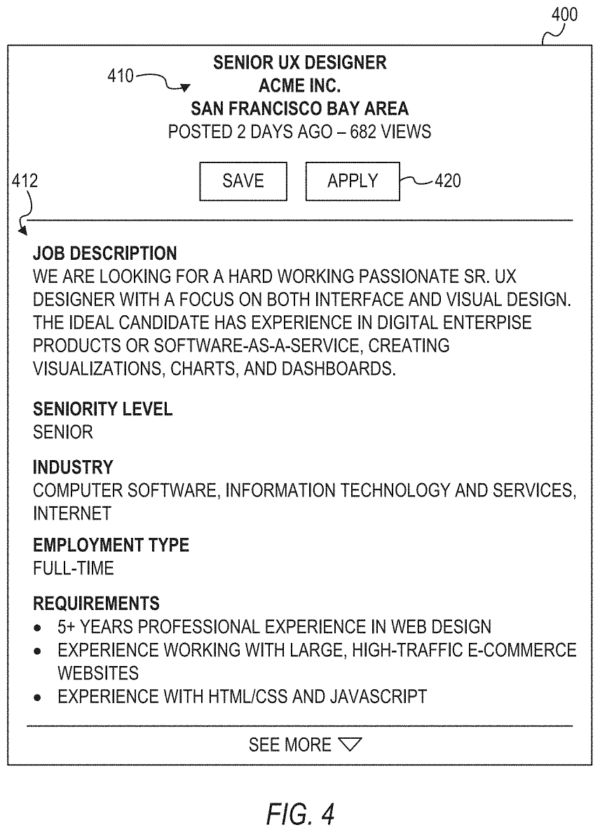

In some example embodiments, the recommendation system 216 provides recommendations of potential content reviewers to a user in the context of job interview preparation for the user. For example, the user may apply for a job via an online job posting, or initiate a job application process for the job, and be presented with recommendations of potential content reviewers, such as potential reviewers of the user's resume, profile, or answers to interview questions. FIGS. 4-12 illustrate graphical user interfaces (GUIs) at different stages of providing recommendations of content reviewers in the context of job interview preparation, in accordance with an example embodiment. In some example embodiments, the interface module 310 is configured to generate and cause the display of the GUIs of FIGS. 4-12, as well as to receive input submitted from a user via the GUIs.

FIG. 4 illustrates a GUI 400 in which users can view a job posting published on an online service, in accordance with an example embodiment. In FIG. 4, the job posting comprises headline information 410 and detailed information 412. The headline information 410 comprises basic information about the job posting, such as the job title or position (e.g., “SENIOR UX DESIGNER”), the name of the company or organization seeking applicants for the job title or position (e.g., “ACME INC.”), and the location of the job (e.g., “SAN FRANCISCO BAY AREA”). The detailed information 412 comprises more detailed information about the job, including, but not limited to, a job description, a seniority level of the job, one or more industries to which the job corresponds, an employment type for the job, and requirements for the job.

In FIG. 4, the GUI 400 also comprises a selectable user interface element 420 configured to enable a user who is viewing the job posting to submit a job application for the job posting. In some example embodiments, the selectable user interface element 420 comprises a selectable button or link (e.g., the selectable “APPLY” button in FIG. 4) that is configured to, when selected, trigger the display of another GUI in which the user can submit an application for the job posting.

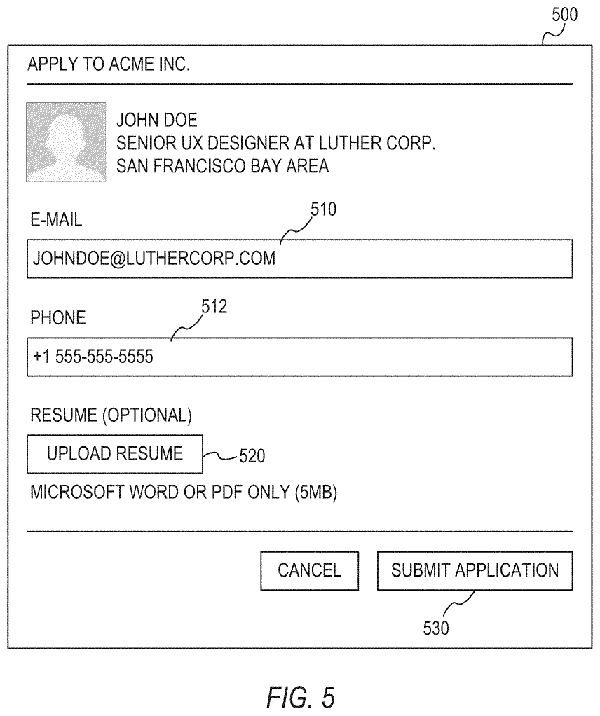

FIG. 5 illustrates a GUI 500 in which a user can submit an application for the job posting, in accordance with an example embodiment. The GUI 500 may be displayed in response to a user selection of the selectable user interface element 420 in FIG. 4. In some example embodiments, the GUI 500 comprises one or more user interface elements configured to enable the user to submit contact information, such as an e-mail address and/or a destination for receiving text messages (e.g., a phone number). For example, the GUI 500 comprises a text field 510 configured to receive an e-mail address of the user, as well as a text field 512 configured to receive a destination for receiving text messages.

In some example embodiments, the GUI 500 also comprises one or more user interface elements configured to enable the user to submit resume data. For example, the GUI 500 comprises a selectable user interface element 520 configured to enable the user to upload a resume in a certain format, such as a Microsoft Word document or a Portable Document Format (PDF). In response to the user selecting the selectable user interface element 520, the merge module 310 may display a window (not shown) in which a user may select a file containing a resume to upload. After the user has entered contact information and uploaded a resume, the user may submit the entered contact information and the uploaded resume file to the online service for processing using a selectable user interface element 530 (e.g., a “SUBMIT APPLICATION” button). The entered contact information and the uploaded resume file may form a job application of the user, who is now recognized by the online service as an applicant for the job posting based on the submission of the entered contact information and the uploaded resume.

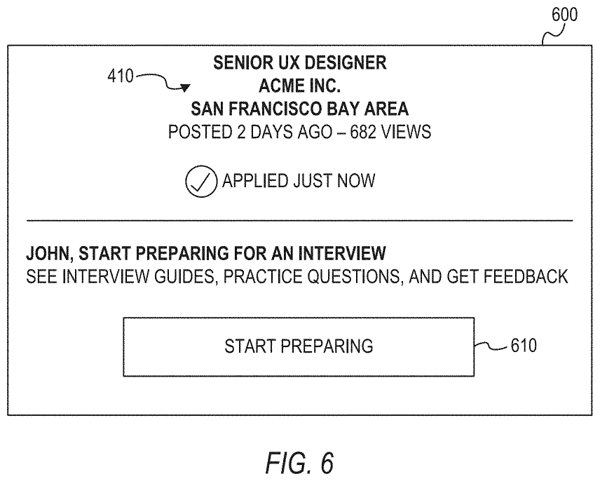

FIG. 6 illustrates a GUI 600 in which a user is provided confirmation that he or she has successfully applied to the online job posting and is now recognized by the online service as an applicant for the job posting, in accordance with an example embodiment. The GUI 600 may be displayed in response to the user submitted a job application for the job posting (e.g., the user submitting contact information and a resume file). In some example embodiments, the GUI 600 comprises a selectable user interface element 610 (e.g., a selectable button) configured to trigger an interview preparation process via the online service.

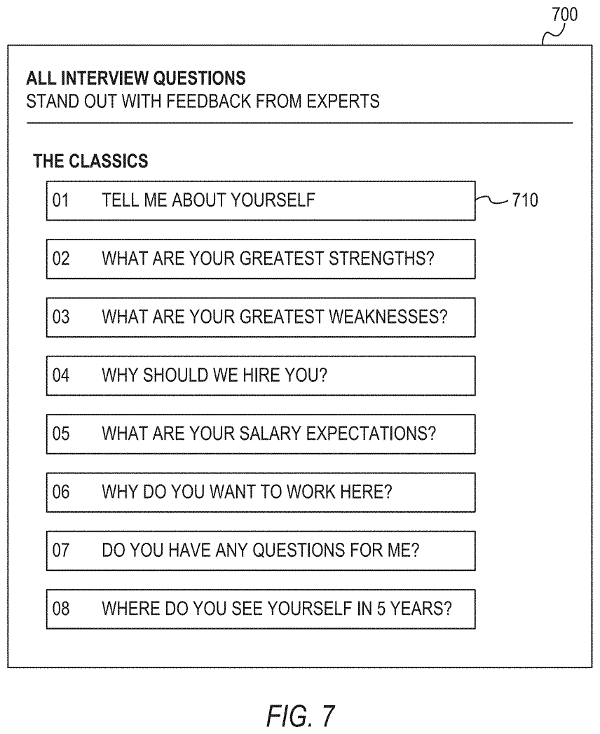

FIG. 7 illustrates a GUI 700 in which a user is provided with multiple selectable user interface elements 710 corresponding to topics of interview questions or subjects. The user may select one of the selectable user interface elements 710 to trigger an online process in which the user provides input with respect to the corresponding topic of the selected user interface element 710 that may be reviewed and commented on by other users of the online service. For example, in the example shown in FIG. 7, the user may select the topic of “TELL ME ABOUT YOURSELF” via selection of the corresponding user interface element 710.

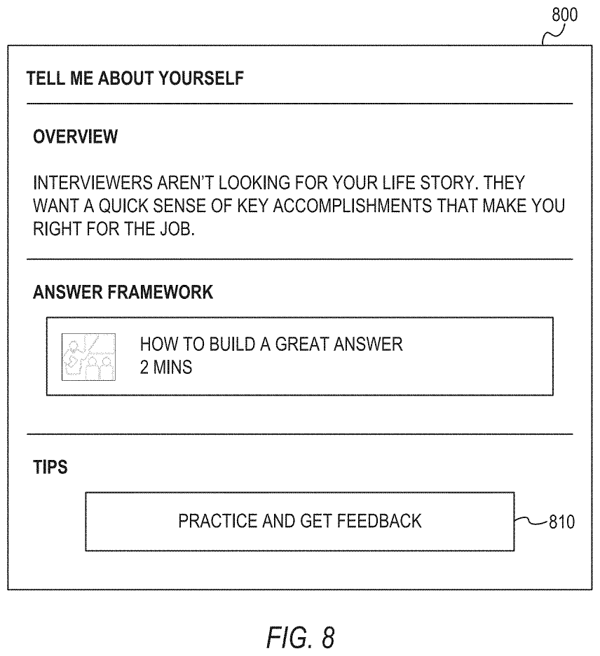

FIG. 8 illustrates a GUI 800 in which the user is provided with information related to the selected topic, such as a text-based overview of the topic (e.g., what interviewers are looking for with respect to the interview question or topic), as well as playable media (e.g., an audio file, a video file) that provides guidance on how the user should answer the interview question. The GUI 800 may be displayed in response to the selection of one of the user interface elements 710 in FIG. 7. In some example embodiments, the GUI 800 comprises a selectable user interface element 810 configured to trigger an online process in which the user practices answering the interview question and receives feedback on his or her answer.

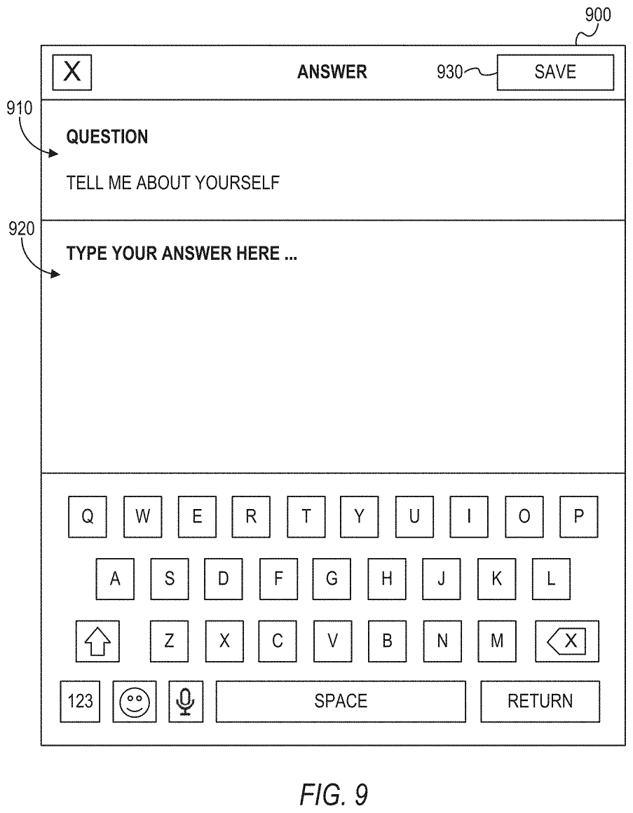

FIG. 9 illustrates a GUI 900 in which the user provides content to be included in an electronic message associated with the selected topic. The GUI 900 may be displayed in response to a selection of the user interface element 810 in FIG. 8. In FIG. 9, the GUI 900 comprises an indication 910 of the selected topic, such as one of the interview topics or questions selected from FIG. 7. The GUI 900 also comprises an input field 920 configured to receive content from the user. The content may include a text-based answer to the selected topic or question, which the user may enter using a keyboard. The GUI 900 may also comprise one or more selectable user interface elements configured to input other types of content that provide the user's answer to the selected topic or question. These other types of content may include, but are not limited to, as a text-based document, a video file, and an audio file. When the user is finished providing content for the answer to the selected topic or question, the user may select a user interface element 930 configured to save the content in association with the selected topic or question for inclusion in a message requesting feedback from another user.

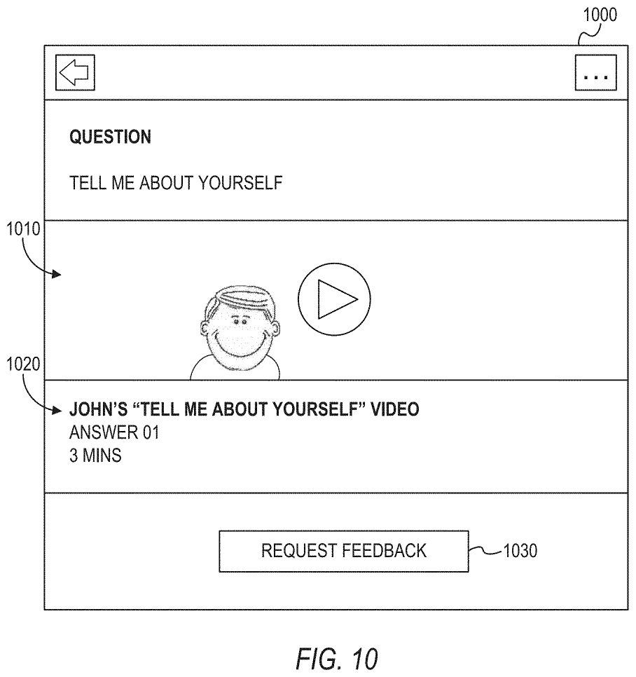

FIG. 10 illustrates a GUI 1000 in which content entered by the user for the selected topic or question is displayed. For example, if the user has submitted a video file of the user providing an answer to the selected topic or question, a representation 1010 of the video file may be displayed in the GUI 1000 along with a description 1020 of the video file in order to inform the user of the content that has been successfully associated with the selected topic or question. The GUI 1000 may be displayed in response to a selection of the user interface element 930 in FIG. 9. In some example embodiments, the GUI 1000 also comprises a selectable user interface element 1030 configured to trigger an online message creation process in which the user creates an electronic message including the content provided by the user.

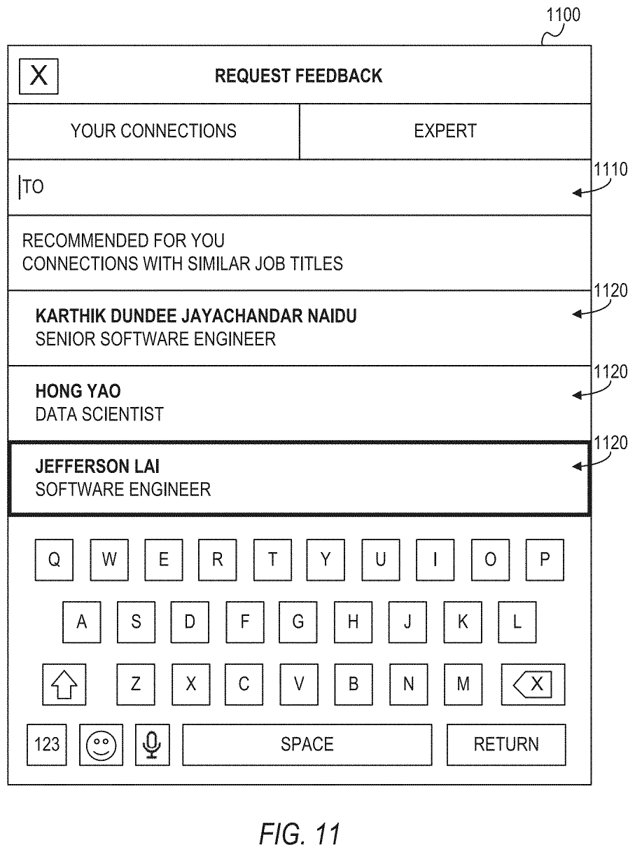

FIG. 11 illustrates a GUI 1100 in which the user selects one or more recipients to which to address an electronic message that includes the content related to the selected topic or question. The GUI 1100 may be displayed in response to a selection of the user interface element 1030 in FIG. 10. In FIG. 11, the GUI 1100 comprises an address field 1110 within which the user may enter a corresponding electronic address of a desired recipient of the electronic message (e.g., an e-mail address of the desired recipient, an identification of the desired recipient that is associated with an e-mail address of the desired recipient). The user may browse his or her connections or a list of experts for a particular topic in order to select a recipient to add to the address field 1110 of the electronic message.

In FIG. 11, the GUI 1100 displays indications 1120 of other users as recommended recipients of the electronic message. In some example embodiments, the identification module 320 is configured to identify a first set of one or more other users based on an indication of the first user using a recommendation model. For example, the identification module 320 may generate corresponding prediction scores for a pool of potential recipients, such as all of other users to whom the user is connected to via the online service, and then select a subset of the pool of potential recipients to display as recommended recipients to the user, such as by ranking the potential recipients based on their corresponding predictions scores and then selecting a portion of the top-ranked potential recipients (e.g., the top five highest ranked potential recipients) or by selecting each potential recipient that has a corresponding prediction score that satisfies a threshold score (e.g., each potential recipient that has a prediction score that is equal to or greater than a minimum threshold value).

In some example embodiments, the scores generated by the recommendation model of the identification module 320 indicate the likelihood of whether the user will select the corresponding potential recipient as someone of whom to request review and feedback for an interview response or other content provided by the user. The recommendation model may be configured to predict the probability p(B/A), where A is a user and B is another user that is a first connection of A, and p(B/A) is the possibility that user A will ask user B for feedback.

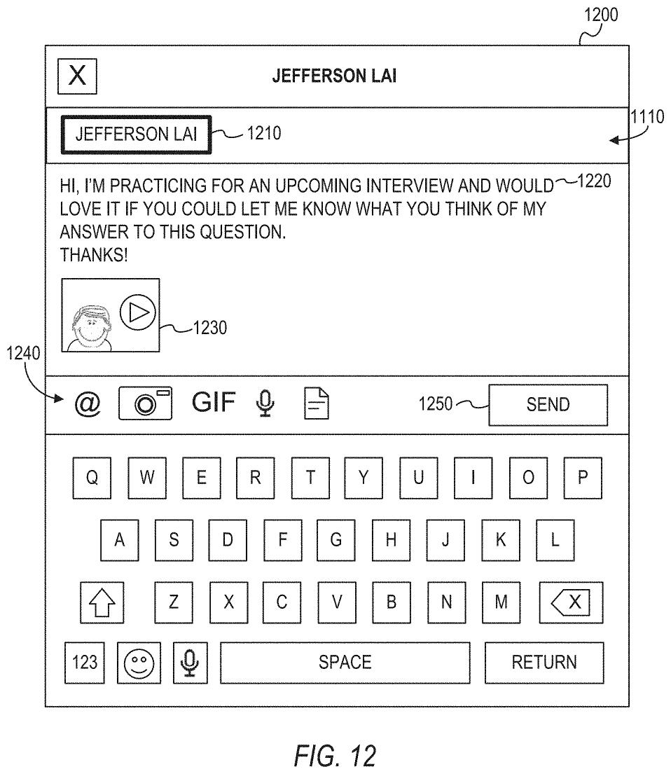

In FIG. 11, the user may select one of the displayed indications 1120 of other users to be used as a recipient for the electronic message. In response to a selection of one of the displayed indications 1120 of other users, the selected other user may be added to the address field of the electronic message. FIG. 12 illustrates a GUI 1200 in which the user has selected one of the indications 1120 of other users displayed in FIG. 11. In FIG. 12, an identification 1210 of the selected other user, or an electronic address associated with the selected other user, is added to the address field 1110 of the electronic message in response to the selection of the other user. In some example embodiments, content, a representation of content, or a link to content input by the user for the purpose of review by the selected other user is also included in the electronic message and displayed in the GUI 1200. For example, in FIG. 12, text 1220 entered by the user and a video 1010 submitted by the user are displayed in the GUI 1200 in association with the electronic message, representing that the text 1220 and the video 1010 will be included in the electronic message when transmitted to the other user selected by the user to be a recipient of the electronic message in response to the user selecting a user interface element 1240 configured to trigger the transmission of the electronic message. In some example embodiments, the GUI 1200 also displays one or more additional selectable user interface elements 1230 configured to enable the user to add additional content to the electronic message, such as an image file, an audio file, or a text file.

In some example embodiments, the identification module 320 is configured to identify the other users to recommend as recipients for the user prior to the user triggering the message creation process. For example, the identification module 320 may generate recommendations of other users to recommend as recipients to the user in an offline process, and then store the recommendations for subsequent retrieval and presentation to the user when the user is creating an electronic message. Alternatively, in some example embodiments, the identification module 320 is configured to identify the other users to recommend as recipients online in real-time in response to, or otherwise based on, the user selecting a user interface element that triggers the message creation process. In some example embodiments, a hybrid offline-online approach is employed in which one or more initial prediction scores are generated offline for the potential recipients using one or more recommendation models prior to the user triggering the message creation process, and then additional prediction scores are generated online in real-time for the potential recipients using one or more other recommendation models in response to, or otherwise based on, the triggering of the message creation process. The identification module 320 may then add the additional prediction scores to the initial prediction scores to generate total prediction scores for the potential recipients, which are then used to select which potential recipients to recommend to the user.

In some example embodiments, the identification module 320 is configured to generate recommendations of one or more other users based on a measure of similarity between a profile of the user and corresponding profiles of the other users. For example, the recommendation model used by the identification module 320 may be based on a measure of similarity between profile data of the user for whom the recommendations are being generates and corresponding profile data of each potential recipient. The profile data may be retrieved from the database 218 in FIG. 2. In some example embodiments, the profile data comprises a corresponding skill set. For example, the identification module 320 may retrieve the corresponding skills of the user and the potential recipients from their corresponding profiles, and then, for each potential recipient, calculate the Jaccard similarity between the skill set, or other profile data, of the user and the skill set, or other profile data, of the potential recipient. The Jaccard similarity measures similarity between finite sample sets and is defined as the size of the intersection divided by the size of the union of the sample sets.

In some example embodiments, the profile data comprises more than one type of profile data. For example, the profile data being evaluated by the identification module 320 may comprise any combination of two or more of the following types of profile data: skills, profile summary, job title, and industry. Other types of profile data and combinations of profile data are also within the scope of the present disclosure.

In some example embodiments, the recommendation model is configured to score and select potential recipients based on corresponding embeddings of the different profile data of the user and the different profile data of each of the potential recipients. An embedding comprises a vector representation that may be generated using a deep learning model. The embedding may comprise a vector representation of text content, such as a word or vocabulary. The embedding is capable of capturing context of a word in a document, as well as semantic and syntactic similarity and relation with other words. For example, every skill may be represented by a vector representation with hundreds of dimensions learned by a deep learning model. Embeddings may be obtained for each type of profile data of the user and the potential recipients, such as one embedding for skills, another embedding for profile summary, yet another embedding for job title, and yet another embedding for industry, and so on and so forth for any combination of different types of profile data. Since certain types of profile data have multiple values, embeddings may be obtained for each value and then summed together to obtain a single embedding for that type of profile data. For example, since a user typically has more than one skill, the identification module 320 may generate or otherwise obtain a corresponding vector representation for each skill of the user, and then sum together all of the skill vector representations to form a single vector representation that represents the skill set of the user.

In some example embodiments, the recommendation model is configured to generate the recommendation score for a potential recipient based on a measure of similarity between the embeddings of the user and the embeddings of the potential recipient. For example, the recommendation model may calculate a cosine similarity score for each potential recipient with respect to the user, and then select one or more of the potential recipients for recommendation based on the cosine similarity scores. The recommendation model may calculate scores based on comparisons of individual types of profile data, such as comparing a potential recipient's skill embedding with the user's skill embedding. However, the recommendation model may also calculate scores based on comparisons of more than one type of profile data, such as a comparison of skills embeddings, profile summary embeddings, job title embeddings, and industry embeddings.

In some example embodiments, the recommendation model uses a comprehensive comparison of the user's profile and the potential recipient's profile, comparing one or more factors including, but not limited to, textual similarity of the profiles, similarity of skills, and career trajectory. This comprehensive comparison may be used to generate a similarity score, such as a cosine similarity score, that is used to select one or more potential recipients for recommendation to the user.

In some example embodiments, the recommendation model is based on, for each potential recipient, a corresponding measure of interaction between the user and potential recipient. Such measure of interaction may include, but is not limited to, a number of messages transmitted between the user and the potential recipient, as well as a number of social media actions between the user and the potential recipient, such as a number of times the user has “liked” or commented on content authored by or otherwise associated with the potential recipient. This interaction data may be retrieved from the database 222 in FIG. 2.

In some example embodiments, the recommendation model is based on content of the electronic message. The content may include, but is not limited to, a topic associated with the electronic message (e.g., selected topic 710 “TELL ME ABOUT YOURSELF” in FIG. 7), at least one of text within a body field of the electronic message (e.g., text 1220 in FIG. 12), a text file attached included in the electronic message, a video file included in the electronic message, and an audio file included in the electronic message. In some example embodiments, the identification module 320 uses natural language processing to analyse the content. The identification module 320 may also use speech-to-text conversion to first convert a video file or audio file included in the electronic message to textual data that can be analysed for use in the recommendation model. In some example embodiments, the recommendation model comprises a combination of different models, such as combination of a model that generates cosine scores for user embeddings and another model that generates scores for the level of interaction between the user and the potential recipient.

In some example embodiments, the machine learning module 330 is configured to use clickstream data and track events to determine how well the recommendation model is performing. For example, the machine learning module 330 may retrieve user behaviour data from the database 222 to determine whether the user is selecting potential recipients that are being presented by the recommendation system 216 as recommendations, and whether selected potential recipients who are sent electronic messages requesting feedback are actually providing feedback, such as via a reply message. If the potential recipients who are recommended to the user are indeed being asked for feedback, and, to close the loop, if they are providing feedback to the user, then these signals may be interpreted as a positive signal to the machine learning module 330, which may boost the relevant features of the recommendation model.

In some example embodiments, in order to avoid data or recommendations becoming stale, the identification module 320 uses online impression discounting to re-rank the recommendations on the fly and lower the potential recipients who have been requested too often or have provided a lot of high quality feedback, in favor of other potential recipients who have not received as many requests.

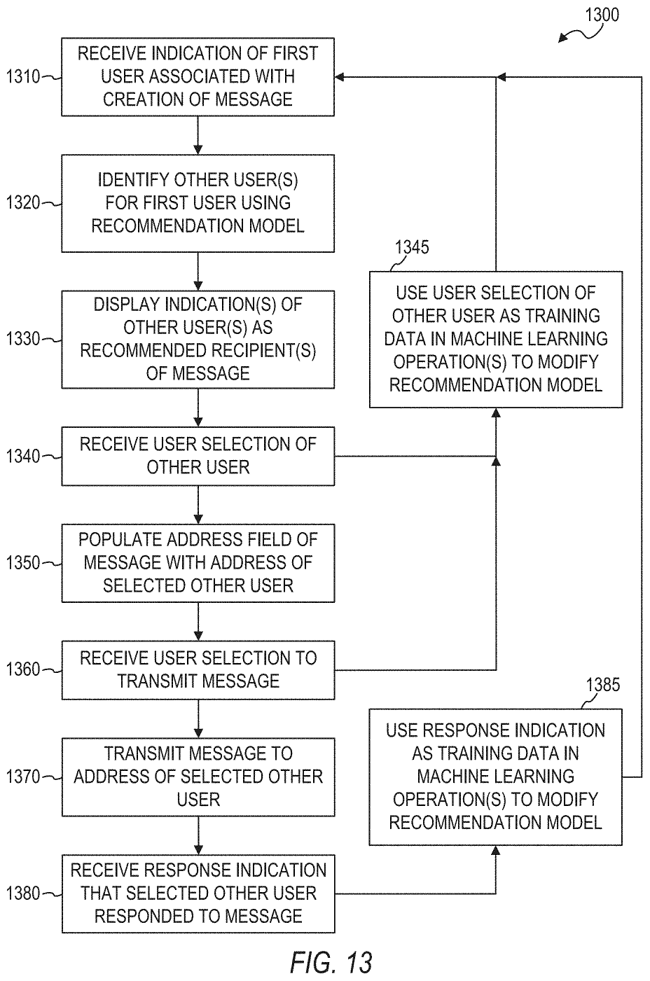

FIG. 13 is a flowchart illustrating a method 1300 of providing recommendations of content reviewers, in accordance with an example embodiment. The method 1300 can be performed by processing logic that can comprise hardware (e.g., circuitry, dedicated logic, programmable logic, microcode, etc.), software (e.g., instructions run on a processing device), or a combination thereof. In one implementation, the method 1300 is performed by the recommendation system 216 of FIGS. 2-3, or any combination of one or more of its modules (e.g., the interface module 310, the identification module 320, the machine learning module 330), as described above.

At operation 1310, the recommendation system 216 receives an indication of a first user associated with a creation of an electronic message. In some example embodiments, the indication comprises a selection, by the first user, of a user interface element that is configured to trigger a message creation process.

At operation 1320, the recommendation system 216 identifies a first set of one or more other users based on the indication of the first user using a recommendation model. Operation 1320 may be performed prior to operation 1310 or may be performed in response to, or otherwise based on, the performance of operation 1310. In some example embodiments, the recommendation model is based on a measure of similarity between profile data of the first user and corresponding profile data of each user in the first set of one or more other users. In some example embodiments, the profile data of the first user and the corresponding profile data of each user in the first set of one or more other users comprise one or more skills. In some example embodiments, the profile data of the first user and the corresponding profile data of each user in the first set of one or more other users comprise more than one type of profile data. In some example embodiments, the more than one type of profile data comprises more than one of skills, profile summary, job title, and industry.

In some example embodiments, the recommendation model is based on, for each user in the first set of one or more other users, a corresponding measure of interaction between the first user and the user in the first set of one or more other users. In some example embodiments, the recommendation model is based on content of the electronic message, the content comprising a topic associated with the electronic message, at least one of text within a body field of the electronic message, a text file attached included in the electronic message, a video file included in the electronic message, and an audio file included in the electronic message.

At operation 1330, the recommendation system 216 causes a corresponding indication of each one of the identified first set of one or more other users to be displayed as a recommended recipient of the electronic message within a user interface of a computing device. For example, a corresponding indication of each one of the identified first set of one or more other users may be displayed in association with an address field of an electronic message within a user interface configured to create the electronic message.

At operation 1340, the recommendation system 216 receives a user selection of the corresponding indication of one of the identified first set of one or more other users. For example, the user may click or tap on the corresponding indication of one of the identified first set of one or more other users.

At operation 1350, the recommendation system 216 populates an address field of the electronic message with an electronic address of the selected one of the identified first set of one or more users, or with an identification of the selected one that is associated with an electronic address, based on the user selection.

At operation 1360, the recommendation system 216 receives another user selection to transmit the electronic message. For example, the recommendation system 216 may receive a selection of a “SEND” button or some other type of selectable user interface element configured to provide an instruction to transmit the electronic message.

At operation 1370, the recommendation system 216 transmits the electronic message to the electronic address of the selected one of the identified first set of one or more users based on the receiving of the other user selection to transmit the electronic message.

At operation 1380, the recommendation system 216 receives a response indication that the selected one of the identified first set of one or more users responded to the electronic message.

In some example embodiments, the recommendation system 216 uses training data in at least one machine learning operation to modify the recommendation model, which may then be used in subsequent performance of the method 1300. For example, in response to or otherwise based on the user selection of the corresponding indication of the one of the identified first set of one or more other users at operation 1340 or the user selection to transmit the electronic message at operation 1360, the recommendation system 216 may use the user selection of the corresponding indication of the one of the identified first set of one or more other users as training data in at least one machine learning operation to modify the recommendation model, which may then be used in subsequent performances of the method 1300. Additionally, in response to or otherwise based on the receiving of the response indication at operation 1380, the recommendation system 216 may use the response indication as training data in at least one machine learning operation to modify the recommendation model, which may then be used in subsequent performances of the method 1300.

It is contemplated that any of the other features described within the present disclosure can be incorporated into the method 1300.

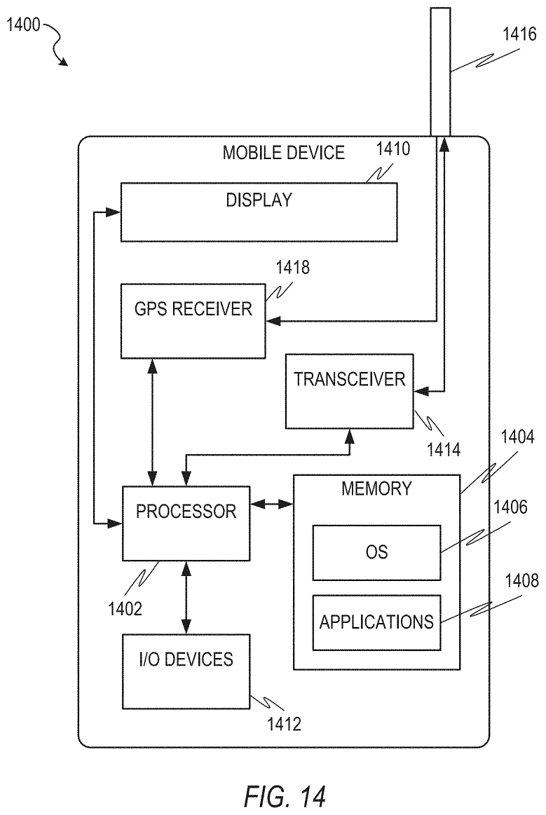

FIG. 14 is a block diagram illustrating a mobile device 1400, according to an example embodiment. The mobile device 1400 can include a processor 1402. The processor 1402 can be any of a variety of different types of commercially available processors suitable for mobile devices 1400 (for example, an XScale architecture microprocessor, a Microprocessor without Interlocked Pipeline Stages (MIPS) architecture processor, or another type of processor). A memory 1404, such as a random access memory (RAM), a Flash memory, or other type of memory, is typically accessible to the processor 1402. The memory 1404 can be adapted to store an operating system (OS) 1406, as well as application programs 1408, such as a mobile location-enabled application that can provide location-based services (LBSs) to a user. The processor 1402 can be coupled, either directly or via appropriate intermediary hardware, to a display 1410 and to one or more input/output (I/O) devices 1412, such as a keypad, a touch panel sensor, a microphone, and the like. Similarly, in some embodiments, the processor 1402 can be coupled to a transceiver 1414 that interfaces with an antenna 1416. The transceiver 1414 can be configured to both transmit and receive cellular network signals, wireless data signals, or other types of signals via the antenna 1416, depending on the nature of the mobile device 1400. Further, in some configurations, a GPS receiver 1418 can also make use of the antenna 1416 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

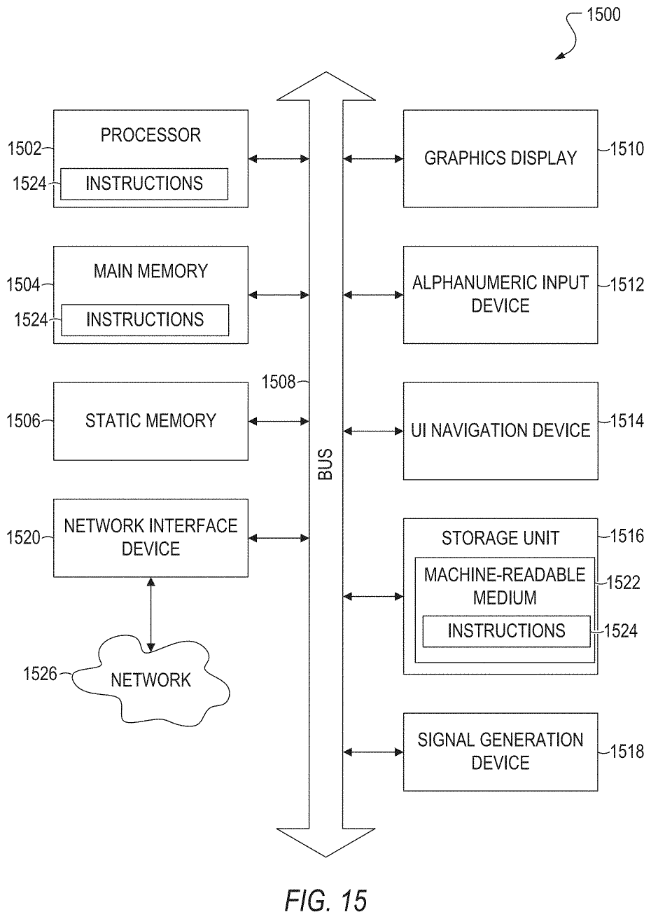

FIG. 15 is a block diagram of an example computer system 1500 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a graphics display unit 1510 (e.g., a liquid crystal display (LCD) or a cathode ray tube (CRT)). The computer system 1500 also includes an alphanumeric input device 1512 (e.g., a keyboard or a touch-sensitive display screen), a user interface (UI) navigation device 1514 (e.g., a mouse), a storage unit 1516, a signal generation device 1518 (e.g., a speaker) and a network interface device 1520.

The storage unit 1516 includes a machine-readable medium 1522 on which is stored one or more sets of instructions and data structures (e.g., software) 1524 embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media.

While the machine-readable medium 1522 is shown in an example embodiment to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding or carrying instructions (e.g., instructions 1524) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising:
   receiving, by a computer system having a memory and at least one hardware processor, an indication of a first user associated with a creation of an electronic message;
   identifying, by the computer system, a first set of one or more other users for the first user using a recommendation model; and
   causing, by the computer system, a corresponding indication of each one of the identified first set of one or more other users to be displayed as a recommended recipient of the electronic message within a user interface of a computing device.
2. The computer-implemented method of example 1, further comprising:
   receiving, by the computer system, a user selection of the corresponding indication of one of the identified first set of one or more other users; and
   populating, by the computer system, an address field of the electronic message with an electronic address of the selected one of the identified first set of one or more other users based on the user selection.
3. The computer-implemented method of example 1 or example 2, further comprising:
   receiving, by the computer system, another user selection to transmit the electronic message; and
   transmitting, by the computer system, the electronic message to the electronic address of the selected one of the identified first set of one or more users based on the receiving of the other user selection to transmit the electronic message.
4. The computer-implemented method of any one of examples 1 to 3, further comprising:
   using, by the computer system, the user selection of the corresponding indication of the one of the identified first set of one or more other users as training data in at least one machine learning operation to modify the recommendation model;
   receiving, by the computer system, another indication of the first user associated with another creation of another electronic message;
   identifying, by the computer system, a second set of one or more other users for the first user using the modified recommendation model; and
   causing, by the computer system, another corresponding indication of each one of the identified second set of one or more other users to be displayed as a recommended recipient of the other electronic message within another user interface of the computing device.
5. The computer-implemented method of any one of examples 1 to 4, further comprising:
   receiving, by the computer system, a response indication that the selected one of the identified first set of one or more users responded to the electronic message;
   using, by the computer system, the response indication as training data in at least one machine learning operation to modify the recommendation model;
   receiving, by the computer system, another indication of the first user associated with another creation of another electronic message;
   identifying, by the computer system, a second set of one or more other users for the first user using the modified recommendation model; and
   causing, by the computer system, another corresponding indication of each one of the identified second set of one or more other users to be displayed as a recommended recipient of the other electronic message within another user interface of the computing device.
6. The computer-implemented method of any one of examples 1 to 5, wherein the recommendation model is based on a measure of similarity between profile data of the first user and corresponding profile data of each user in the first set of one or more other users.
7. The computer-implemented method of any one of examples 1 to 6, wherein the profile data of the first user and the corresponding profile data of each user in the first set of one or more other users comprise one or more skills.
8. The computer-implemented method of any one of examples 1 to 7, wherein the profile data of the first user and the corresponding profile data of each user in the first set of one or more other users comprise more than one type of profile data.
9. The computer-implemented method of any one of examples 1 to 8, wherein the more than one type of profile data comprises more than one of skills, profile summary, job title, and industry.
10. The computer-implemented method of any one of examples 1 to 9, wherein the recommendation model is based on, for each user in the first set of one or more other users, a corresponding measure of interaction between the first user and the user in the first set of one or more other users.
11. The computer-implemented method of any one of examples 1 to 10, wherein the recommendation model is based on content of the electronic message, the content comprising a topic associated with the electronic message, at least one of text within a body field of the electronic message, a text file attached included in the electronic message, a video file included in the electronic message, and an audio file included in the electronic message.
12. A system comprising:
   at least one processor; and
   a non-transitory computer-readable medium storing executable instructions that, when executed, cause the at least one processor to perform the method of any one of examples 1 to 11.
13. A non-transitory machine-readable storage medium, tangibly embodying a set of instructions that, when executed by at least one processor, causes the at least one processor to perform the method of any one of examples 1 to 11.
14. A machine-readable medium carrying a set of instructions that, when executed by at least one processor, causes the at least one processor to carry out the method of any one of examples 1 to 11.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving, by a computer system having a memory and at least one hardware processor, an indication of a first user associated with a creation of an electronic message;
identifying, by the computer system, a first set of one or more other users for the first user using a recommendation model;
causing, by the computer system, a corresponding indication of each one of the identified first set of one or more other users to be displayed as a recommended recipient of the electronic message within a user interface of a computing device;
receiving, by the computer system, a user selection of the corresponding indication of one of the identified first set of one or more other users; and
populating, by the computer system, an address field of the electronic message with an electronic address of the selected one of the identified first set of one or more other users based on the user selection.

2. The computer-implemented method of claim 1, further comprising:
receiving, by the computer system, another user selection to transmit the electronic message; and
transmitting, by the computer system, the electronic message to the electronic address of the selected one of the identified first set of one or more users based on the receiving of the other user selection to transmit the electronic message.

3. The computer-implemented method of claim 2, further comprising:
using, by the computer system, the user selection of the corresponding indication of the one of the identified first set of one or more other users as training data in at least one machine learning operation to modify the recommendation model;
receiving, by the computer system, another indication of the first user associated with another creation of another electronic message;
identifying, by the computer system, a second set of one or more other users for the first user using the modified recommendation model; and
causing, by the computer system, another corresponding indication of each one of the identified second set of one or more other users to be displayed as a recommended recipient of the other electronic message within another user interface of the computing device.

4. The computer-implemented method of claim 2, further comprising:
receiving, by the computer system, a response indication that the selected one of the identified first set of one or more users responded to the electronic message;
using, by the computer system, the response indication as training data in at least one machine learning operation to modify the recommendation model;
receiving, by the computer system, another indication of the first user associated with another creation of another electronic message;
identifying, by the computer system, a second set of one or more other users for the first user using the modified recommendation model; and
causing, by the computer system, another corresponding indication of each one of the identified second set of one or more other users to be displayed as a recommended recipient of the other electronic message within another user interface of the computing device.

5. The computer-implemented method of claim 1, wherein the recommendation model is based on a measure of similarity between profile data of the first user and corresponding profile data of each user in the first set of one or more other users.

6. The computer-implemented method of claim 5, wherein the profile data of the first user and the corresponding profile data of each user in the first set of one or more other users comprise one or more skills.

7. The computer-implemented method of claim 5, wherein the profile data of the first user and the corresponding profile data of each user in the first set of one or more other users comprise more than one type of profile data.

8. The computer-implemented method of claim 7, wherein the more than one type of profile data comprises more than one of skills, profile summary, job title, and industry.

9. The computer-implemented method of claim 1, wherein the recommendation model is based on, for each user in the first set of one or more other users, a corresponding measure of interaction between the first user and the user in the first set of one or more other users.

10. The computer-implemented method of claim 1, wherein the recommendation model is based on content of the electronic message, the content comprising a topic associated with the electronic message, at least one of text within a body field of the electronic message, a text file attached included in the electronic message, a video file included in the electronic message, and an audio file included in the electronic message.

11. A system comprising:
at least one hardware processor; and
a non-transitory machine-readable medium embodying a set of instructions that, when executed by the at least one hardware processor, cause the at least one processor to perform operations, the operations comprising:
receiving an indication of a first user associated with a creation of an electronic message;
identifying a first set of one or more other users for the first user using a recommendation model;
causing a corresponding indication of each one of the identified first set of one or more other users to be displayed as a recommended recipient of the electronic message within a user interface of a computing device;
receiving a user selection of the corresponding indication of one of the identified first set of one or more other users; and
populating an address field of the electronic message with an electronic address of the selected one of the identified first set of one or more other users based on the user selection.

12. The system of claim 11, further comprising:
receiving another user selection to transmit the electronic message; and
transmitting the electronic message to the electronic address of the selected one of the identified first set of one or more users based on the receiving of the other user selection to transmit the electronic message.

13. The system of claim 12, further comprising:
using the user selection of the corresponding indication of the one of the identified first set of one or more other users as training data in at least one machine learning operation to modify the recommendation model;
receiving another indication of the first user associated with another creation of another electronic message;
identifying a second set of one or more other users for the first user using the modified recommendation model; and
causing another corresponding indication of each one of the identified second set of one or more other users to be displayed as a recommended recipient of the other electronic message within another user interface of the computing device.

14. The system of claim 12, further comprising:
receiving a response indication that the selected one of the identified first set of one or more users responded to the electronic message;
using the response indication as training data in at least one machine learning operation to modify the recommendation model;
receiving another indication of the first user associated with another creation of another electronic message;
identifying a second set of one or more other users for the first user using the modified recommendation model; and
causing another corresponding indication of each one of the identified second set of one or more other users to be displayed as a recommended recipient of the other electronic message within another user interface of the computing device.

15. The system of claim 11, wherein the recommendation model is based on a measure of similarity between profile data of the first user and corresponding profile data of each user in the first set of one or more other users.

16. The system of claim 11, wherein the recommendation model is based on, for each user in the first set of one or more other users, a corresponding measure of interaction between the first user and the user in the first set of one or more other users.

17. The system of claim 11, wherein the recommendation model is based on content of the electronic message, the content comprising a topic associated with the electronic message, at least one of text within a body field of the electronic message, a text file attached included in the electronic message, a video file included in the electronic message, and an audio file included in the electronic message.

18. A non-transitory machine-readable medium embodying a set of instructions that, when executed by at least one hardware processor, cause the processor to perform operations, the operations comprising:
receiving an indication of a first user associated with a creation of an electronic message;
identifying a first set of one or more other users for the first user using a recommendation model;
causing a corresponding indication of each one of the identified first set of one or more other users to be displayed as a recommended recipient of the electronic message within a user interface of a computing device;
receiving a user selection of the corresponding indication of one of the identified first set of one or more other users; and
populating an address field of the electronic message with an electronic address of the selected one of the identified first set of one or more other users based on the user selection.

19. The non-transitory machine-readable medium of claim 18, wherein the operations further comprise:
receiving another user selection to transmit the electronic message; and
transmitting the electronic message to the electronic address of the selected one of the identified first set of one or more users based on the receiving of the other user selection to transmit the electronic message.

20. The non-transitory machine-readable medium of claim 19, wherein the operations further comprise:
using the user selection of the corresponding indication of the one of the identified first set of one or more other users as training data in at least one machine learning operation to modify the recommendation model;
receiving another indication of the first user associated with another creation of another electronic message;
identifying a second set of one or more other users for the first user using the modified recommendation model; and
causing another corresponding indication of each one of the identified second set of one or more other users to be displayed as a recommended recipient of the other electronic message within another user interface of the computing device.
